(19) United States
(12) Patent Application Publication
(10) Pub. No.: US 2026/0196214 A1
(43) Pub. Date: Jul. 9, 2026

(54) INFORMATION PRESENTATION APPARATUS, INFORMATION PRESENTATION METHOD, AND PROGRAM

(71) Applicant: NTT. Inc., Tokyo (JP)

(72) Inventors: Mitsuhiro GOTO, Tokyo (JP); Soichiro UCHIDA, Tokyo (JP); Hitoshi SESHIMO, Tokyo (JP)

(73) Assignee: NTT. Inc., Tokyo (JP)

(21) Appl. No.: 19/131,967

(22) PCT Filed: Dec. 1, 2022
(86) PCT No.: PCT/JP2022/044423

§ 371 Date: May 22, 2025

(51) Int. Cl. G10L 15/183

(52) U.S. Cl. CPC G10L 15/183

(57) ABSTRACT

An information presentation device according to one embodiment includes a determination unit, a selection unit, and a generation unit. The determination unit determines whether an intention of dialogue information related to a dialogue between users is positive or negative. The selection unit selects a modality to be superimposed on the dialogue information on the basis of the determined intention. The generation unit generates subjective sensation forming information for forming a subjective sensation according to the determined intention by using the selected modality.

### TECHNICAL FIELD

Embodiments relate to an information presentation device, an information presentation method, and a program.

### BACKGROUND ART

Against a backdrop of the coronavirus pandemic and the like, a communication form of having an online dialogue has been actively utilized. It is known that, in an online dialogue, transmission of nonverbal elements is often limited as compared with a face-to-face dialogue, and thus contents desired to be conveyed to an interlocutor tend to be difficult to convey.

Many studies utilizing the cross reality or extended reality (XR) technology have been conducted so that contents desired to be conveyed to an interlocutor can be conveyed even in an online dialogue as in a face-to-face dialogue. The XR technology is a generic term for technologies that create new experiences by fusing a real world with a virtual world. As a study utilizing the XR technology, for example, a study is known in which a virtual reality (VR) space or a high-definition video is used so that information to be transmitted to a user is brought closer to that in a face-to-face environment. In these studies, information transmitted to a user in a face-to-face environment is regarded as a correct answer, and information on the correct answer is faithfully reproduced on the basis of audiovisual information.

### CITATION LIST

### Non Patent Literature

Non Patent Literature 1: Pakanen, M., et. al., “Nice to see you virtually”: Thoughtful design and evaluation of virtual avatar of the other user in AR and VR based telexistence systems”, Entertainment Computing, Vol. 40, 2022 Non Patent Literature 2: Sayaka Unno and Katsunobu Ito, “2ch stereophonic sound system using sound field simulation and selective head related transfer function system”, Proceedings of the 82nd National Convention of IPSJ, pp. 561-562, 2020

### SUMMARY OF INVENTION

### Technical Problem

However, in the case of faithfully reproducing information transmitted in a face-to-face environment online, high definition of audiovisual information and high performance of a device cannot be avoided. Furthermore, in the case of faithfully reproducing information transmitted in a face-to-face environment online, limitations are often imposed on use cases. For this reason, there is a concern that the method of faithfully reproducing information transmitted in a face-to-face environment online has a high barrier against introduction to an actual online communication system.

The present invention has been made in view of the above circumstances, and an object of the present invention is to provide a means for presenting information accompanied by the same quality of sensation as that in a face-to-face environment online without faithfully reproducing the face-to-face environment.

### Solution to Problem

An information presentation device according to one aspect includes a determination unit, a selection unit, and a generation unit. The determination unit determines whether an intention of dialogue information related to a dialogue between users is positive or negative. The selection unit selects a modality to be superimposed on the dialogue information on the basis of the determined intention. The generation unit generates subjective sensation forming information for forming a subjective sensation according to the determined intention by using the selected modality.

### Advantageous Effects of Invention

According to embodiments, it is possible to provide a means for presenting information accompanied by the same quality of sensation as that in a face-to-face environment online without faithfully reproducing the face-to-face environment.

### BRIEF DESCRIPTION OF DRAWINGS

FIG. 1 is a block diagram illustrating an example of an information presentation system according to the first embodiment.

FIG. 2 is a block diagram illustrating an example of a hardware configuration of a terminal according to the first embodiment.

FIG. 3 is a block diagram illustrating an example of a hardware configuration of an information presentation device according to the first embodiment.

FIG. 4 is a block diagram illustrating an example of a functional configuration of the information presentation device according to the first embodiment.

FIG. 5 is a diagram illustrating an example of a subjective sensation model according to the first embodiment.

FIG. 6 is a flowchart illustrating an example of information presentation processing in the information presentation device according to the first embodiment.

FIG. 7 is a flowchart illustrating an example of modality selection processing in the information presentation device according to the first embodiment.

FIG. 8 is a block diagram illustrating an example of a functional configuration of an information presentation device according to the second embodiment.

FIG. 9 is a flowchart illustrating an example of information presentation processing in the information presentation device according to the second embodiment.

FIG. 10 is a flowchart illustrating an example of modality selection processing in the information presentation device according to the second embodiment.

### DESCRIPTION OF EMBODIMENTS

Hereinafter, embodiments will be described with reference to the drawings. Note that, in the following description, components having the same function and configuration are denoted by the same reference numerals.

### 1. First Embodiment

### 1.1 Information Presentation System

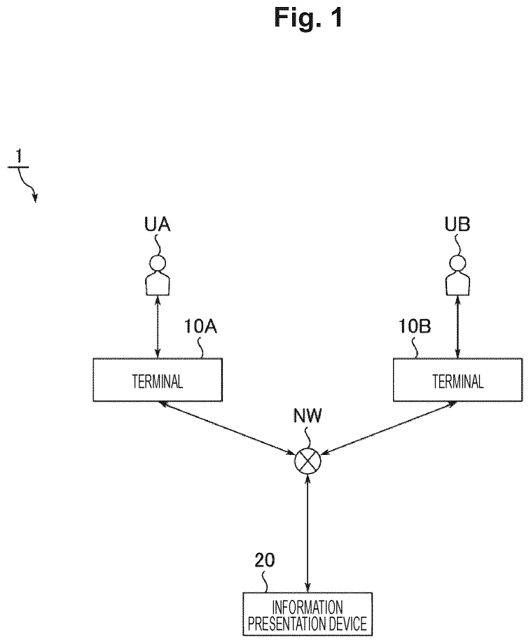

FIG. 1 is a block diagram illustrating an example of an information presentation system according to the first embodiment.

An information presentation system 1 is, for example, a communication system that implements an online dialogue among a plurality of users. The information presentation system 1 includes terminals 10A and 10B and an information presentation device 20. The terminals 10A and 10B and the information presentation device 20 are configured to communicate with each other via a network NW.

Each of the terminals 10A and 10B is a personal computer, a smartphone, or the like. The terminals 10A and 10B are used by users UA and UB, respectively. The users UA and UB have an online dialogue via the network NW using the terminals 10A and 10B.

The information presentation device 20 is, for example, a server that manages the online dialogue. The information presentation device 20 acquires information transmitted in the online dialogue by the users UA and UB (dialogue information) from the terminal 10A and the terminal 10B. On the basis of the dialogue information, the information presentation device 20 presents information for forming the same quality of subjective sensation as that in a face-to-face dialogue performed by the users UA and UB (subjective sensation forming information) to the users UA and UB via the terminal 10A and the terminal 10B. The subjective sensation forming information is, for example, superimposed on the dialogue information with a predetermined modality and presented to the users UA and UB.

### 1.2 Terminal

Next, a configuration of the terminals according to the first embodiment will be described.

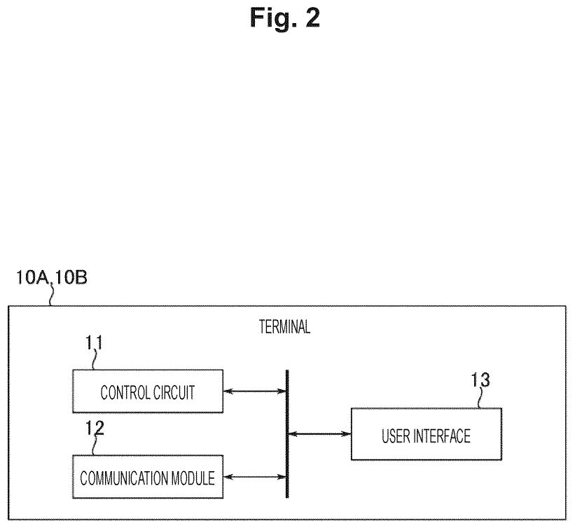

FIG. 2 is a block diagram illustrating an example of a hardware configuration of the terminals according to the first embodiment. As illustrated in FIG. 2, each of the terminals 10A and 10B includes a control circuit 11, a communication module 12, and a user interface 13. The terminals 10A and 10B have configurations equivalent to each other. Hereinafter, the terminals 10A and 10B will be referred to as a terminal 10 unless otherwise distinguished. Similarly, the users UA and UB will be referred to as a user U unless otherwise distinguished.

The control circuit 11 is a circuit that entirely controls each component of the terminal 10. The control circuit 11 includes a central processing unit (CPU), a random access memory (RAM), a read only memory (ROM), and the like. The ROM of the control circuit 11 stores programs and the like used in various types of processing in the terminal 10. The CPU of the control circuit 11 controls the entire terminal 10 according to the programs stored in the ROM of the control circuit 11. The RAM of the control circuit 11 is used as a work area of the CPU of the control circuit 11.

The communication module 12 is a circuit used for data communication with another terminal 10 and data transmission and reception between the terminal 10 and the information presentation device 20.

The user interface 13 is an interface that manages communication between the user U and the control circuit 11. The user interface 13 includes an input device and an output device. The input device includes, for example, a voice microphone, a touch panel, an operation button, and the like. The output device includes, for example, a speaker, a display, and the like. The user interface 13 converts dialogue information from the user U to another user U into an electrical signal, and then transmits the electrical signal to the control circuit 11. The user interface 13 outputs dialogue information from another user U and subjective sensation forming information from the information presentation device 20 to the user U.

### 1.3 Information Presentation Device

Next, a configuration of the information presentation device according to the first embodiment will be described.

### 1.3.1 Hardware Configuration

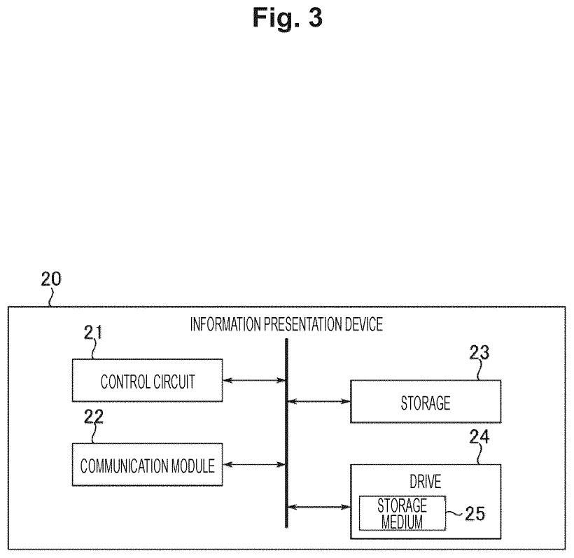

FIG. 3 is a block diagram illustrating an example of a hardware configuration of the information presentation device according to the first embodiment. As illustrated in FIG. 3, the information presentation device 20 includes a control circuit 21, a communication module 22, a storage 23, a drive 24, and a storage medium 25.

The control circuit 21 is a circuit that entirely controls each component of the information presentation device 20. The control circuit 21 includes a CPU, a RAM, a ROM, and the like. The ROM of the control circuit 21 stores programs and the like used in various types of processing in the information presentation device 20. The CPU of the control circuit 21 controls the entire information presentation device 20 according to the programs stored in the ROM of the control circuit 21. The RAM of the control circuit 21 is used as a work area of the CPU of the control circuit 21.

The communication module 22 is a circuit used for data transmission and reception between the information presentation device 20 and the terminal 10.

The storage 23 includes, for example, a hard disk drive (HDD) or a solid state drive (SSD). The storage 23 stores information used in various types of processing in the information presentation device 20.

The drive 24 is a device for reading software stored in the storage medium 25. The drive 24 includes, for example, a compact disk (CD) drive or a digital versatile disk (DVD) drive.

The storage medium 25 is a medium that stores software by electrical, magnetic, optical, mechanical, or chemical action. The storage medium 25 may store programs for executing various types of processing in the information presentation device 20.

### 1.3.2 Functional Configuration

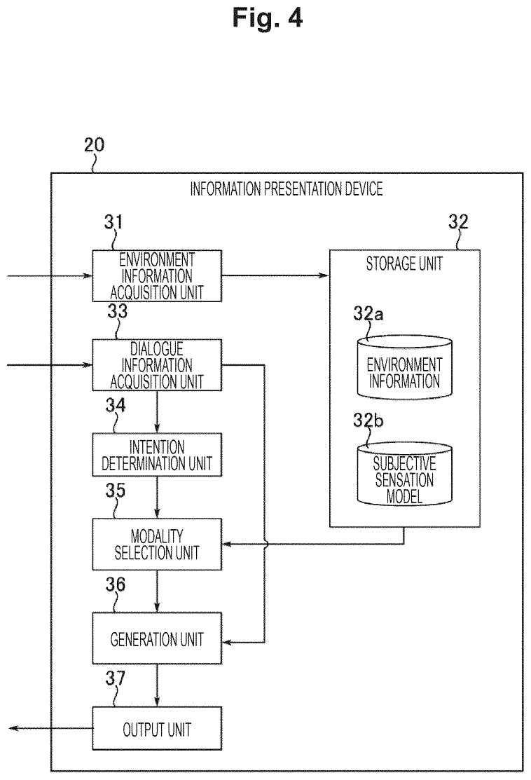

FIG. 4 is a block diagram illustrating an example of a functional configuration of the information presentation device according to the first embodiment. The CPU of the control circuit 21 develops a program stored in the ROM of the control circuit 21 or the storage medium 25 into the RAM of the control circuit 21. The CPU of the control circuit 21 then interprets and executes the program developed in the RAM of the control circuit 21. As a result, the information presentation device 20 functions as a computer including an environment information acquisition unit 31, a storage unit 32, a dialogue information acquisition unit 33, an intention determination unit 34, a modality selection unit 35, a generation unit 36, and an output unit 37.

The environment information acquisition unit 31 acquires environment information 32a from the terminal 10 on the reception side. The environment information 32a includes the type of information output from the user interface 13 on the reception side to the user U in the dialogue between the users U. Specifically, for example, the environment information 32a includes information indicating whether the user interface 13 on the reception side provides visual information to the user U and information indicating whether the user interface 13 on the reception side provides auditory information to the user U. The environment information acquisition unit 31 stores the acquired environment information 32a in the storage unit 32.

The storage unit 32 is a memory area of the storage 23. The storage unit 32 stores the environment information 32a and a subjective sensation model 32b.

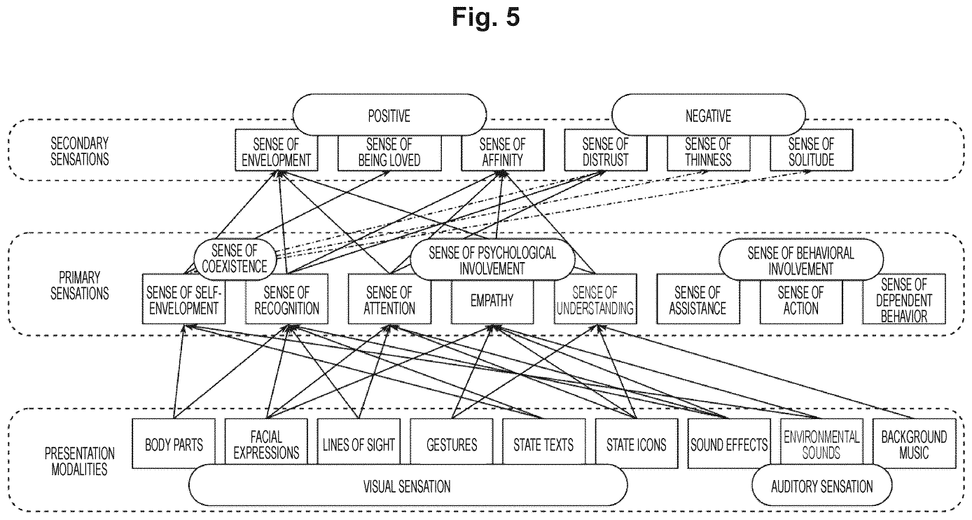

FIG. 5 is a diagram illustrating an example of the subjective sensation model according to the first embodiment. As illustrated in FIG. 5, the subjective sensation model 32b is represented as a three-layer model including, for example, secondary sensations, primary sensations, and presentation modalities.

The presentation modalities are types of modes of subjective sensation forming information to be superimposed on dialogue information. The presentation modalities are classified into, for example, visual modalities and auditory modalities. Examples of the presentation modalities classified into the visual modalities include body parts, facial expressions, lines of sight, gestures, state texts, and state icons. Examples of the presentation modalities classified into the auditory modalities include sound effects, environmental sounds, and background music.

The primary sensations are describable sensations that are easily expressed on an outer surface of a person, such as presence or absence of a sense of existence and perspective of a sense of distance. The primary sensations are classified into, for example, a sense of coexistence, a sense of psychological involvement, and a sense of behavioral involvement. Examples of the primary sensations classified into the sense of coexistence include a sense of self-envelopment and a sense of recognition. Examples of the primary sensations classified into the sense of psychological involvement include a sense of attention, empathy, and a sense of understanding. Examples of the primary sensations classified into the sense of behavioral involvement include a sense of assistance, a sense of action, and a sense of dependent behavior.

The secondary sensations are non-describable sensations that are formed on an inner surface of a person, such as a sense of being with an interlocutor of a dialogue in the same room and satisfaction of a dialogue. The secondary sensations are classified into, for example, positive secondary sensations and negative secondary sensations. Examples of the positive secondary sensations include a sense of envelopment, a sense of being loved, and a sense of affinity. Regarding the degree of positive, for example, the sense of affinity is the highest among the sense of envelopment, the sense of being loved, and the sense of affinity, the sense of being loved is the second highest, and the sense of envelopment is the lowest. Examples of the negative secondary sensations include a sense of distrust, a sense of thinness, and a sense of solitude. Regarding the degree of negative, for example, the sense of solitude is the highest among the sense of distrust, the sense of thinness, and the sense of solitude, the sense of thinness is the second highest, and the sense of distrust is the lowest.

The subjective sensation model 32b shows the relevance between the secondary sensations and the primary sensations involved in the formation of the secondary sensation, and the relevance between the primary sensations and the presentation modalities involved in the formation of the primary sensations.

In the example of FIG. 5, it is shown that the body parts, the state texts, and the environmental sounds, which serve as presentation modalities, are involved in the formation of the sense of self-envelopment, which is a primary sensation. It is shown that the body parts, the facial expressions, the lines of sight, the state texts, and the sound effects, which serve as presentation modalities, are involved in the formation of the sense of recognition, which is a primary sensation. It is shown that the facial expressions, the lines of sight, the state icons, and the sound effects, which serve as presentation modalities, are involved in the formation of the sense of attention, which is a primary sensation. It is shown that the facial expressions, the gestures, the state icons, the sound effects, and the environmental sounds, which serve as presentation modalities, are involved in the formation of the empathy, which is a primary sensation. It is shown that the gestures, the state icons, and the background music, which serve as presentation modalities, are involved in the formation of the sense of understanding, which is a primary sensation.

Furthermore, in the example of FIG. 5, it is shown that the sense of self-envelopment, the sense of recognition, the sense of attention, and the sense of understanding, which serve as primary sensations, are involved in the formation of the sense of envelopment, which is a secondary sensation. It is shown that the sense of self-envelopment, which serves as a primary sensation, is involved in the formation of the sense of being loved, which is a secondary sensation. It is shown that the sense of recognition, the sense of attention, the empathy, and the sense of understanding, which serve as primary sensations, are involved in the formation of the sense of affinity, which is a secondary sensation. It is shown that, in the formation of the sense of distrust, which is a secondary sensation, the sense of recognition and the sense of attention, which serve as primary sensations, are positively involved, and the sense of self-envelopment is negatively involved. It is shown that the sense of self-envelopment, which serves as a primary sensation, is negatively involved in the formation of the sense of thinness and the sense of solitude, which are secondary sensations.

The subjective sensation model 32b as described above is designed in advance on the basis of findings obtained from meta-reviews, experiments, or the like of computer mediated communication (CMC) research.

The functional configuration of the information presentation device 20 will be described again with reference to FIG. 4.

The dialogue information acquisition unit 33 acquires dialogue information from the terminal 10 on the transmission side. The dialogue information includes a video and a voice. The voice in the dialogue information includes a speech speed and a sound pressure. Specifically, the dialogue information acquisition unit 33 performs voice recognition on a speech action, and calculates the speech speed from the number of spoken characters per unit time. Furthermore, the dialogue information acquisition unit 33 records the speech action, and measures the sound pressure on the basis of the recorded information. The dialogue information acquisition unit 33 transmits the acquired dialogue information to the intention determination unit 34.

On the basis of the dialogue information, the intention determination unit 34 determines an intention of the dialogue included in the dialogue information by the user U on the transmission side for the user U on the reception side. The intention of the dialogue indicates whether the secondary sensation that the user U on the transmission side wants the user U on the reception side to form is positive or negative. That is, the intention determination unit 34 determines whether the intention of the dialogue information is positive or negative on the basis of the dialogue information.

Specifically, for example, in a case where the speech speed of the dialogue information is greater than or equal to the first threshold value and/or the sound pressure is smaller than or equal to the second threshold value, the intention determination unit 34 determines that the secondary sensation that the user U on the transmission side wants the user U on the reception side to form is negative. In a case where the speech speed of the dialogue information is smaller than the first threshold value and/or the sound pressure exceeds the second threshold value, the intention determination unit 34 determines that the secondary sensation that the user U on the transmission side wants the user U on the reception side to form is positive. Furthermore, the intention determination unit 34 may include the degree of divergence of the speech speed from the first threshold value and the degree of divergence of the sound pressure from the second threshold value in the determination result. The intention determination unit 34 transmits the determination result to the modality selection unit 35.

The modality selection unit 35 selects a modality of the subjective sensation forming information to be superimposed on the dialogue information on the basis of the determination result by the intention determination unit 34 and the subjective sensation model 32b.

Specifically, the modality selection unit 35 selects a secondary sensation to be formed by the user U on the reception side from the subjective sensation model 32b on the basis of the intention determined by the intention determination unit 34. The modality selection unit 35 may select a secondary sensation according to the magnitude of the degree of divergence. In a case where the determination result is positive, the modality selection unit 35 may change the secondary sensation to be selected in the order of the sense of envelopment, the sense of being loved, and the sense of affinity as the degree of divergence increases. In a case where the determination result is negative, the modality selection unit 35 may change the secondary sensation to be selected in the order of the sense of distrust, the sense of thinness, and the sense of solitude as the degree of divergence increases.

In addition, the modality selection unit 35 selects a primary sensation associated with the selected secondary sensation from the subjective sensation model 32b on the basis of the subjective sensation model 32b. The modality selection unit 35 then selects a presentation modality associated with the selected primary sensation. When selecting a presentation modality, the modality selection unit 35 may select a presentation modality from among modalities that can be presented to the user U by the terminal 10 on the reception side on the basis of the environment information 32a. The modality selection unit 35 transmits information indicating the selected presentation modality to the generation unit 36.

The generation unit 36 generates the subjective sensation forming information on the basis of the presentation modality. In a case where the presentation modality is a visual modality, the generation unit 36 superimposes the subjective sensation forming information on the video of the dialogue information, for example. In a case where the presentation modality is an auditory modality, the generation unit 36 superimposes the subjective sensation forming information on the voice of the dialogue information, for example. The generation unit 36 transmits the generated subjective sensation forming information to the output unit 37.

The output unit 37 outputs the generated subjective sensation forming information to the terminal 10 on the reception side via the network NW.

With the above configuration, the user U on the reception side can have a dialogue with the user U on the transmission side on the basis of the dialogue information on which the subjective sensation forming information is superimposed.

### 1.2 Operation

Next, an operation of the information presentation device according to the first embodiment will be described.

### 1.2.1 Information Presentation Processing

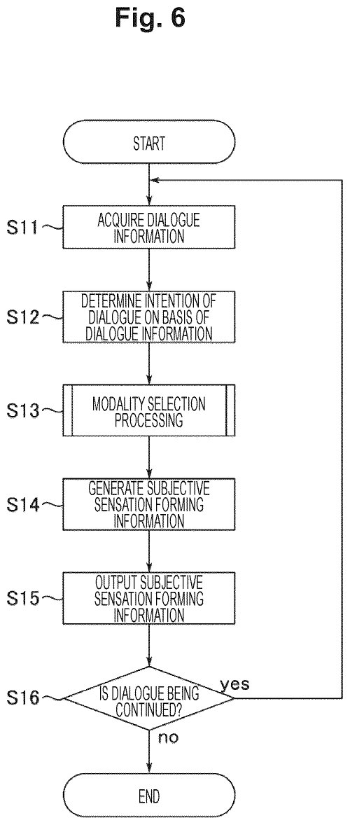

FIG. 6 is a flowchart illustrating an example of information presentation processing in the information presentation device according to the first embodiment. Note that it is assumed that the environment information acquisition unit 31 acquires the environment information 32a in advance before the information presentation processing.

When an online dialogue between the users U starts (start), the dialogue information acquisition unit 33 acquires dialogue information transmitted from the terminal 10 on the transmission side to the terminal 10 on the reception side via the network NW (S11).

The intention determination unit 34 determines an intention of the dialogue on the basis of the dialogue information acquired in the processing of S11 (S12). Specifically, for example, in a case where the speech speed of the dialogue information is greater than or equal to the first threshold value and/or in a case where the sound pressure is smaller than or equal to the second threshold value, the intention determination unit 34 determines that the secondary sensation that the user U on the transmission side wants the user U on the reception side to form is negative. In a case where the speech speed of the dialogue information is smaller than the first threshold value and/or the sound pressure exceeds the second threshold value, the intention determination unit 34 determines that the secondary sensation that the user U on the transmission side wants the user U on the reception side to form is positive.

The modality selection unit 35 executes modality selection processing on the basis of the intention of the dialogue determined in the processing of S12 (S13). Details of the modality selection processing will be described later.

The generation unit 36 generates subjective sensation forming information for forming a subjective sensation according to the intention determined in the processing of S12 by using the presentation modality selected in the processing of S13 (S14).

The output unit 37 superimposes the subjective sensation forming information generated in the processing of S14 on the dialogue information acquired in the processing of S11, and outputs the obtained information to the terminal 10 on the reception side (S15).

The dialogue information acquisition unit 33 determines whether the online dialogue between the users U is being continued (S16).

If the dialogue is being continued (S16; yes), the dialogue information acquisition unit 33 continues to acquire dialogue information (S11). Thereafter, the subsequent processing of S12 to S16 is executed. In this manner, the processing of S11 to S16 is repeated until the dialogue has ended.

If the dialogue has ended (S16; no), the information presentation processing ends (end).

### 1.2.2 Modality Selection Processing

Next, the modality selection processing in the information presentation device according to the first embodiment will be described.

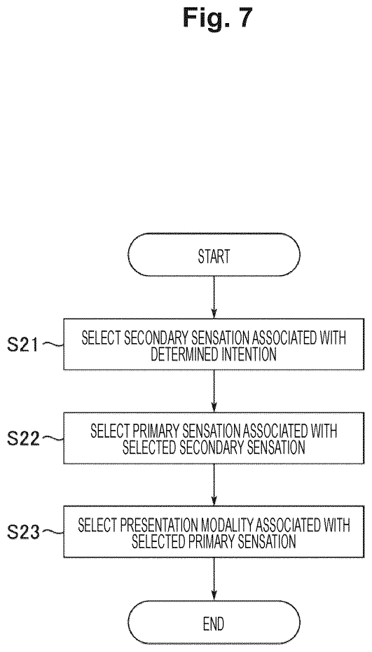

FIG. 7 is a flowchart illustrating an example of the modality selection processing in the information presentation device according to the first embodiment. The processing of S21 to S23 illustrated in FIG. 7 is details of the processing of S13 in FIG. 6.

When the modality selection processing starts (start), the modality selection unit 35 selects a secondary sensation associated with the intention determined in the processing of S12 (S21). Specifically, in a case where it is determined that the intention is positive, the modality selection unit 35 selects the sense of envelopment, the sense of being loved, or the sense of affinity as a secondary sensation. In a case where it is determined that the intention is negative, the modality selection unit 35 selects the sense of distrust, the sense of thinness, or the sense of solitude as a secondary sensation. For example, the modality selection unit 35 can determine the secondary sensation to be selected according to the degree of divergence between the threshold values and the parameters such as the speech speed and the sound pressure used for determination of the intention.

The modality selection unit 35 selects a primary sensation associated with the secondary sensation selected in the processing of S21 (S22). In a case where there is a plurality of primary sensations associated with secondary sensation, the modality selection unit 35 can select one primary sensation from the plurality of primary sensations according to a predetermined rule (for example, the primary sensation on the left side is preferentially selected from the plurality of primary sensations illustrated in FIG. 5).

The modality selection unit 35 selects a presentation modality associated with the primary sensation selected in the processing of S22 (S23). In a case where there is a plurality of presentation modalities associated with the primary sensation, the modality selection unit 35 can simultaneously select the plurality of presentation modalities. When selecting a presentation modality, the modality selection unit 35 can select a presentation modality that can be output by the terminal 10 on the reception side on the basis of the environment information 32a.

After the processing of S23, the modality selection processing ends (end).

### 1.3 Effects According to First Embodiment

According to the first embodiment, the intention determination unit 34 determines whether an intention of dialogue information related to a dialogue between the users U is positive or negative. The modality selection unit 35 selects a presentation modality to be superimposed on the dialogue information on the basis of the determined intention. The generation unit 36 generates subjective sensation forming information for forming a subjective sensation according to the determined intention by using the selected presentation modality. As a result, in addition to the dialogue information, the subjective sensation forming information can be presented to the user U on the reception side. Therefore, it is possible to cause the user U on the reception side to form the subjective sensation according to the intention of the dialogue even online, where it is more difficult to notice the true intention of the dialogue than in a face-to-face dialogue. Therefore, it is possible to provide a means for presenting information accompanied by the same quality of sensation as that in a face-to-face environment online without faithfully reproducing the face-to-face environment.

Furthermore, the modality selection unit 35 also selects a secondary sensation associated with the determined intention. The modality selection unit 35 selects a primary sensation associated with the selected secondary sensation. The modality selection unit 35 selects a presentation modality associated with the selected primary sensation. As a result, a modality suitable for the secondary sensation to be formed can be selected on a model basis using the subjective sensation model 32b.

Furthermore, the intention determination unit 34 determines that the intention is negative in a case where a speech speed in the dialogue information is greater than or equal to the first threshold value, and determines that the intention is positive in a case where the speech speed in the dialogue information is smaller than the first threshold value. The intention determination unit 34 determines that the intention is positive in a case where a sound pressure in the dialogue information is greater than or equal to the second threshold value, and determines that the intention is negative in a case where the sound pressure in the dialogue information is smaller than the second threshold value. As a result, the intention of the dialogue can be determined on the basis of the state of the speech of the user U on the transmission side.

In addition, the presentation modality includes a visual modality and an auditory modality. The visual modality includes at least one selected from a body part, a facial expression, a line of sight, a gesture, a text, and an icon. The auditory modality includes at least one selected from a sound effect, an environmental sound, and background music. As a result, an appropriate presentation modality can be selected according to the secondary sensation to be formed.

### 2. Second Embodiment

Next, an information presentation device according to the second embodiment will be described. In the first embodiment, the case where an intention is determined on the basis of dialogue information has been described. The second embodiment is different from the first embodiment in that an intention of a dialogue is clearly indicated from the user U on the transmission side. Hereinafter, configurations and operations different from those of the first embodiment will be mainly described. The description of configurations and operations equivalent to those of the first embodiment will be omitted as appropriate.

### 2.1 Information Presentation Device

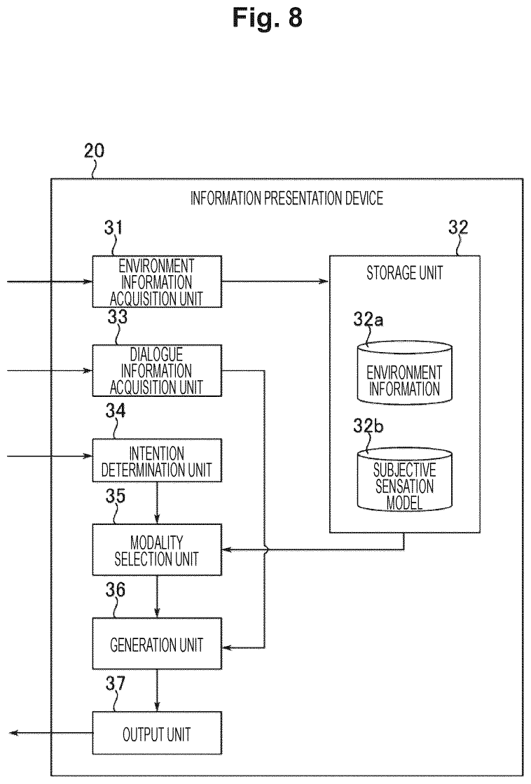

FIG. 8 is a block diagram illustrating an example of a functional configuration of the information presentation device according to the second embodiment.

As illustrated in FIG. 8, the intention determination unit 34 may acquire intention information from the terminal 10 on the transmission side. The intention information is information including whether an intention of a dialogue is positive or negative. The intention information may include information indicating a specific secondary sensation. The intention information is transmitted to the information presentation device 20 via the network NW when the user U on the transmission side inputs the intention information to the terminal 10 on the transmission side at the time of dialogue.

### 2.2 Information Presentation Processing

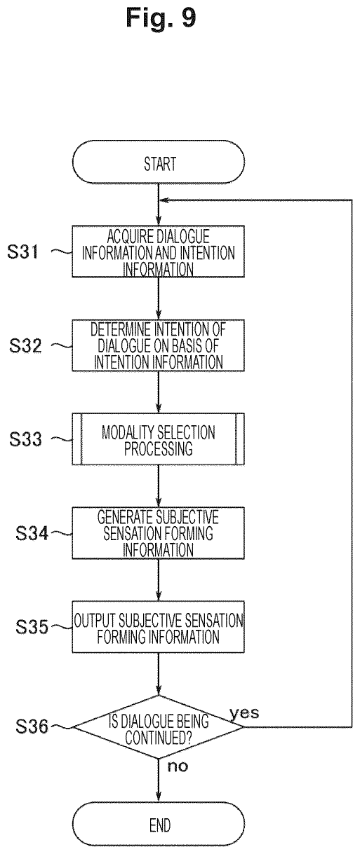

FIG. 9 is a flowchart illustrating an example of information presentation processing in the information presentation device according to the second embodiment.

When an online dialogue between the users U starts (start), the dialogue information acquisition unit 33 acquires dialogue information and intention information from the terminal 10 on the transmission side via the network NW (S31). The intention information does not have to be transmitted to the terminal 10 on the reception side.

The intention determination unit 34 determines an intention of the dialogue on the basis of the intention information acquired in the processing of S31 (S32). Specifically, in a case where the intention information indicates being positive, the intention determination unit 34 determines that the intention of the dialogue is positive. In a case where the intention information indicates being negative, the intention determination unit 34 determines that the intention of the dialogue is negative.

The modality selection unit 35 executes modality selection processing on the basis of the intention of the dialogue determined in the processing of S32 (S33). Details of the modality selection processing will be described later.

The generation unit 36 generates subjective sensation forming information for forming a subjective sensation according to the intention determined in the processing of S32 by using the presentation modality selected in the processing of S33 (S34).

The output unit 37 superimposes the subjective sensation forming information generated in the processing of S34 on the dialogue information acquired in the processing of S31, and outputs the obtained information to the terminal 10 on the reception side (S35).

The dialogue information acquisition unit 33 determines whether the online dialogue between the users U is being continued (S36).

If the dialogue is being continued (S36; yes), the dialogue information acquisition unit 33 continues to acquire dialogue information and intention information (S31). Thereafter, the subsequent processing of S32 to S36 is executed. In this manner, the processing of S31 to S36 is repeated until the dialogue has ended.

If the dialogue has ended (S36; no), the information presentation processing ends (end).

### 2.3 Modality Presentation Processing

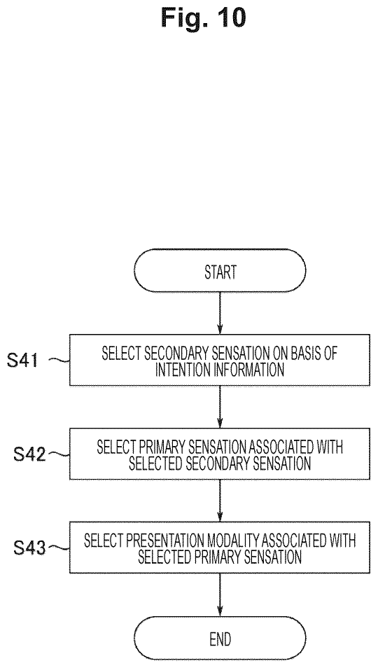

FIG. 10 is a flowchart illustrating an example of the modality selection processing in the information presentation device according to the second embodiment.

When the modality selection processing starts (starts), the modality selection unit 35 selects a secondary sensation associated with a positive intention on the basis of the intention information acquired in the processing of S31 (S41). In a case where the intention information does not include information clearly indicating a specific secondary sensation, the processing of S41 is substantially equivalent to the processing of S21 in the first embodiment. In a case where the intention information includes information clearly indicating a specific secondary sensation, the modality selection unit 35 uniquely selects the secondary sensation on the basis of the information clearly indicating the secondary sensation included in the intention information.

The modality selection unit 35 selects a primary sensation associated with the secondary sensation selected in the processing of S41 (S42).

The modality selection unit 35 selects a presentation modality associated with the primary sensation selected in the processing of S42 (S43).

After the processing of S43, the modality selection processing ends (end).

### 2.4 Effects According to Second Embodiment

According to the second embodiment, the intention determination unit 34 can uniquely determine an intention of a dialogue without being based on dialogue information. Furthermore, in a case where intention information includes information indicating a secondary sensation, the modality selection unit 35 can uniquely select the secondary sensation from the subjective sensation model 32b. As a result, even in a case where contents of determination based on the dialogue information is different from the intention that the user U on the transmission side truly wants to convey, the generation unit 36 can generate subjective sensation forming information on the basis of the intention that the user U on the transmission side truly wants to convey. Therefore, for example, even in a case where dialogue information that seems to have a negative intention online is spoken, it is possible to present subjective sensation forming information according to a true intention of the user U on the transmission side, who wants the user U on the reception side to increase the sense of affinity. Therefore, it is possible to present information accompanied by the same quality of sensation as that in a face-to-face environment online without faithfully reproducing the face-to-face environment.

### 3. Modifications and the Like

Note that various modifications can be applied to the first embodiment and the second embodiment described above.

In the first embodiment and the second embodiment described above, the cases where the type of information output from the terminal 10 on the reception side to the user U is included in the environment information 32a have been described, but the present invention is not limited thereto. For example, the environment information 32a may include information regarding dominant modalities in the user U on the reception side. According to the present modification, for example, in a case where the dominant modalities in the user U on the reception side are the visual modalities, the modality selection unit 35 can preferentially select a visual modality. Furthermore, for example, in a case where the user U on the reception side has a slight visual impairment and it is easier to communicate by hearing, the modality selection unit 35 can preferentially select an auditory modality. As a result, it is possible to select a more effective modality for the user U on the reception side. Therefore, it is possible to present information accompanied by the same quality of sensation as that in a face-to-face environment online without faithfully reproducing the face-to-face environment.

In the first embodiment and the second embodiment described above, the cases where the subjective sensation forming information is superimposed on one-to-one dialogue information between the user UA and the user UB have been described, but the present invention is not limited thereto. For example, the subjective sensation forming information may be superimposed on one-to-many dialogue information between a certain user U and a plurality of users U.

In the first embodiment and the second embodiment described above, the cases where the information presentation processing is applied to the dialogue between the users U have been described, but the present invention is not limited thereto. For example, the information presentation processing may be applied to a dialogue between VR avatars in virtual space. In this case, a presentation modality of the subjective sensation forming information is a gesture, a facial expression, or the like of a VR avatar, and thus the degree of freedom of superimposing the subjective sensation forming information on the dialogue information increases.

In the first embodiment and the second embodiment described above, the cases where the information presentation processing is applied to the dialogue executed in real time have been described, but the present invention is not limited thereto. For example, the information presentation processing may be applied to recorded dialogue information.

In the first embodiment and the second embodiment described above, the cases where the program for executing the information presentation processing and the modality selection processing is executed by the information presentation device 20 have been described, but the present invention is not limited thereto. For example, the program for executing the information presentation processing and the modality selection processing may be executed by calculation resources on a cloud.

Note that the present invention is not limited to the above embodiments, and various modifications can be made in the implementation stage without departing from the gist of the invention. In addition, the embodiments may be implemented in appropriate combination, and in this case, a combined effect can be obtained. Furthermore, the above embodiments include various inventions, and various inventions can be extracted by a combination selected from the plurality of disclosed components. For example, in a case where the problems can be solved and the effects can be obtained even if some components are deleted from all the components described in the embodiments, a configuration from which the components are deleted can be extracted as an invention.

### REFERENCE SIGNS LIST

1 Information presentation system
10A, 10B, 10 Terminal
11 Control circuit
12 Communication module
13 User interface
20 Information presentation device
21 Control circuit
22 Communication module
23 Storage
24 Drive
25 Storage medium
31 Environment information acquisition unit
32 Storage unit
32a Environment information
32b Subjective sensation model
33 Dialogue information acquisition unit
34 Intention determination unit
35 Modality selection unit
36 Generation unit
37 Output unit

1. An information presentation device comprising:
determination circuitry that determines whether an intention of dialogue information related to a dialogue between users is positive or negative;
selection circuitry that selects a modality to be superimposed on the dialogue information on a basis of the determined intention; and
generation circuitry that generates subjective sensation forming information for forming a subjective sensation according to the determined intention by using the selected modality.

2. The information presentation device according to claim 1, wherein the selection circuitry:
selects a secondary sensation associated with the determined intention,
selects a primary sensation associated with the selected secondary sensation, and
selects a modality associated with the selected primary sensation.

3. The information presentation device according to claim 1, wherein:
the dialogue information includes a speech speed of the dialogue, and
the determination circuitry:
determines that the intention is negative in a case where the speech speed is greater than or equal to a first threshold value, and
determines that the intention is positive in a case where the speech speed is smaller than the first threshold value.

4. The information presentation device according to claim 1, wherein:
the dialogue information includes a sound pressure of the dialogue, and
the determination circuitry:
determines that the intention is positive in a case where the sound pressure is greater than or equal to a second threshold value, and
determines that the intention is negative in a case where the sound pressure is smaller than the second threshold value.

5. The information presentation device according to claim 1, wherein:
the dialogue information includes intention information clearly indicating an intention of the dialogue, and
the determination circuitry uniquely determines the intention of the dialogue on a basis of the intention information.

6. The information presentation device according to claim 1, wherein:
the modality includes a visual modality and an auditory modality,
the visual modality includes at least one selected from a body part, a facial expression, a line of sight, a gesture, a text, and an icon, and
the auditory modality includes at least one selected from a sound effect, an environmental sound, and background music.

7. An information presentation method comprising:
determining whether an intention of dialogue information related to a dialogue between users is positive or negative on a basis of the dialogue information;
selecting a modality of subjective sensation forming information to be superimposed on the dialogue information on a basis of the determined intention; and
generating the subjective sensation forming information by using the selected modality.

8. A non-transitory computer readable medium storing a program which when executed by a processor causes the processor to perform the information presentation method of claim 7.
